(19) United States
(12) Patent Application Publication
(10) Pub. No.: US 2015/0239208 A1
(43) Pub. Date: Aug. 27, 2015

(54) COMPOSITE FOAM MATERIAL AND METHOD OF MAKING AND USING THE SAME

(71) Applicant: GM Global Technology Operations LLC, Detroit, MI (US)

(72) Inventor: Christopher G. Basela, Ortonville, MI (US)

(73) Assignee: GM Global Technology Operations LLC, Detroit, MI (US)

(21) Appl. No.: 14/189,166

(22) Filed: Feb. 25, 2014

(51) Int. Cl. B32B 5/18; B32B 5/24; B32B 37/14; B32B 7/12

(52) U.S. Cl. CPC B32B 5/18; B32B 7/12; B32B 5/245; B32B 37/144; B32B 2262/02; B32B 2262/065; B32B 2262/101; B32B 2607/00; B32B 2605/18; B32B 2605/08; B32B 2605/10; B32B 2605/12

(57) ABSTRACT

A number of variations may include a composite material and method of manufacture thereof wherein the composite material may be fabricated from a first core, a second core comprising foam, a bonding agent, and a skin, wherein the skin at least partially overlays the first core and the second core.

### TECHNICAL FIELD

The field to which the disclosure generally relates to includes composite materials, including, but not limited to composite materials used in vehicle frames and structures, such as, but not limited to frames or structures included in passenger vehicles, motor cycles, bicycles, rough terrain vehicles, watercraft, trains, aircraft, or spacecraft.

### BACKGROUND

Currently, some composite materials may be formed to contain an organic core to provide floor or bulkhead construction in some vehicles.

### SUMMARY OF ILLUSTRATIVE VARIATIONS

One variation of the invention shows a product comprising a composite material comprising a first core, a second core comprising foam, a bonding agent, and a skin, wherein the skin at least partially overlays the first core and the second core.

Another variation of the invention shows a method of manufacturing a composite material comprising: providing a first core, a second core, a first skin, a second skin, and a first bonding agent a second bonding agent, and a mold cavity, positioning the first skin in the mold cavity, positioning the first bonding agent in contact with the first skin, positioning the second core over the first skin, positioning the first core over the first skin, positioning the second bonding agent in contact with the second skin, positioning the second skin over the second core and the first core, and, curing to form the composite material.

Other illustrative variations within the scope of the invention will become apparent from the detailed description provided hereinafter. It should be understood that the detailed description and specific examples, while disclosing optional variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a cross-sectional view of one variation of the composite material.

### DETAILED DESCRIPTION OF ILLUSTRATIVE VARIATIONS

The following description within the scope of the variations is merely illustrative in nature and is in no way intended to limit the scope of invention, its application, or uses.

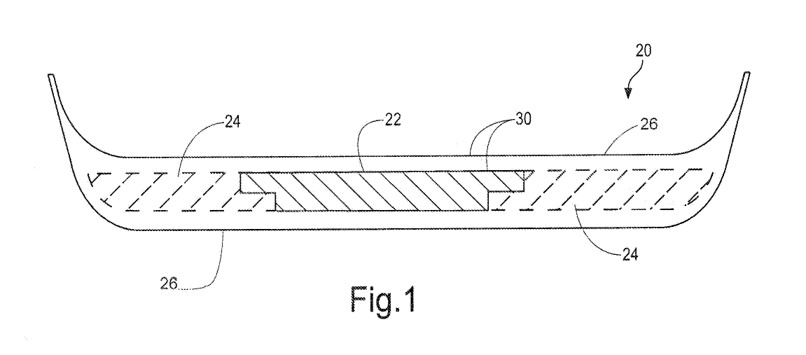

A composite material 20 is provided in FIG. 1. Such a composite material 20 may be useful in applications such as frames, bulkheads, floors, front dashboards, side panels, front panels, rear panels, doors, and rear seatbacks of a vehicle or may be used for other applications. The composite material 20 may provide higher plane stiffness, impact resistance, and acoustic noise reduction over other composite materials. In one variation, the composite material 20 may include a plurality of layers. In one variation, the composite material 20 may include a first core 22. In one variation, the first core 22 may comprise a plurality of fibers. The fibers may be textile, natural or synthetic or may be another type. The fibers in the first core 22 may include animal, vegetable, or mineral fibers including, but not limited to, at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomax), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), basalt, or may be another type. The skin may be a metal including at least one of stainless steel, titanium, steel, cast iron, alloy steel, stainless steel, platinum, palladium, aluminum, copper, nickel, iron, lead, tin, cobalt, bronze, or may be another type. The first core 22 may contain combinations of the above in varying concentrations and the components may be intermixed. The first core 22 may be formed by sheets, continuous mats, or as continuous filaments. The first core 22 may be manufactured or woven through weaving, knitting, braiding, stitching, plain weaving, satin weaving, or may be manufactured in another way. The first core 22 can be manufactured in a two dimensional or three dimensional orientation. The first core 22 may be formed using a hand lay-up operation, an extrusion operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. The first core 22 may include short-fiber reinforced materials or continuous fiber-reinforced materials or may include another type. The first core 22 may have various widths, lengths and/or diameters of fibers as well as in its overall dimensions and may be shaped to fit its desired application. The core 22 may be preimpregnated, coated, or otherwise in contact with a bonding agent 30.

Still referring to FIG. 1, in one variation the composite material 20 may include a second core 24. In one variation, the second core 24 may comprise a plurality of fibers. The fibers may be textile, natural or synthetic or may be another type. The fibers in the second core 24 may include animal, vegetable, or mineral fibers including, but not limited to, at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomax), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), basalt, aluminum, or may be another type. The second core 24 may contain combinations of the above in varying concentrations and the components may be intermixed. The second core 24 may be formed by sheets, continuous mats, or as continuous filaments. The second core 24 may be manufactured or woven through weaving, knitting, braiding, stitching, plain weaving, satin weaving, or may be manufactured in another way. The second core 24 can be manufactured in a two dimensional or three dimensional orientation. The second core 24 may be formed using a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. The second core 24 may include short-fiber reinforced materials or continuous fiber-reinforced materials or may include another type. The second core 24 may have various widths, lengths and/or diameters of fibers as well as in its overall dimensions and may be shaped to fit its desired application. In one variation, the second core 24 may comprise a foam. The foam may be an open-cell foam or a closed-cell foam. The foam may be a ballistic foam, a nanofoam, a syntactic foam, an integral skin foam, a solid foam, a liquid foam, or may be another type. The foam may be low-expansion, high-expansion, alcohol-resistant or may be another type. The foam may be low-density or high-density. In a number of variations the foam may have a density of between 6 lbs/ft² and 24 lbs/ft². The foam may include an organic polymer, a ceramic, or a metal. The foam may include at least one of polyurethane, polyester, alumina, beryllia, ceria, zirconia, silicide, nitride, boride, carbide, a surfactant, an organic solvent, a protein foam (including, but not limited to, regular protein foam, fluoroprotein foam, film-forming fluoroprotein, alcohol-resistant fluoroprotein foam, or alcohol-resistant film-forming fluoroprotein), high density, Evlon, rubber, Supreem, Rebond, Memory Foam, Polyether, Polyethylene, Crosslinked Polyethylene, Latex, Neoprene, Ethafoam, Polystyrene, Styrofoam™, Polyfoam, Nimbus, IMPAXX™ or may include another type. The foam may contain bubbles of any shape including, but not limited to, polyhedron, spheres, or may be another type. The second core 24 may be preimpregnated, coated, or otherwise in contact with a bonding agent 30.

Still referring to FIG. 1, in one variation the composite material 20 may include a skin 26. In one variation, the skin 26 may comprise a plurality of fibers. The fibers may be textile, natural or synthetic or may be another type. The fibers in the skin 26 may include at least one of animal, vegetable, or mineral fibers including, but not limited to, alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomax), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), basalt, aluminum, or may be another type. The skin may be a metal including at least one of stainless steel, titanium, steel, cast iron, alloy steel, stainless steel, platinum, palladium, aluminum, copper, nickel, iron, lead, tin, cobalt, bronze, or may be another type. The skin 26 may contain combinations of the above in varying concentrations and the components may be intermixed. The skin 26 may be formed by sheets, continuous mats, or as continuous filaments. The skin 26 may be manufactured or woven through weaving, knitting, braiding, stitching, plain weaving, satin weaving, or may be manufactured in another way. The skin 26 can be manufactured in a two dimensional or three dimensional orientation. The skin 26 may be formed using a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. The skin 26 may include short-fiber reinforced materials or continuous fiber-reinforced materials or may include another type. The skin 26 may have various widths, lengths and/or diameters of fibers as well as in its overall dimensions and may be shaped to fit its desired application. The skin 26 may be preimpregnated, coated, or otherwise in contact with a bonding agent 30.

Still referring to FIG. 1, a bonding agent 30 may be held in contact with the first core 22, second core 24, or skin 26. This contact may result in adherence, binding, or bonding between the bonding agent 30, first core 22, second core 24, skin 26, or any combination thereof. The bonding agent 30 may include urethane resin, vinylester resin, polyester resin, epoxy resin, phenolic resin, modified phenolic resin or may be another type. The bonding agent 30 may be reactive or non-reactive.

The composite material 20 may be produced by various fabrication or manufacturing methods. The composite material 20 may be in two or three dimensional orientation. The first core 22, second core 24, or skin 26, or any combination may be manufactured or woven through weaving, knitting, braiding, stitching, plain weaving, satin weaving, or may be manufactured another way. In one variation, at least one of a weave, a knit, a braid, a stitch, a plain weave, or a satin weave can be added to the first core 22, second core 24, or skin 26, or any combination during manufacture or fabrication. Some examples of orientations of the at least one of a weave, a knit, a braid, a stitch, a plain weave, or a satin weave including, but are not limited to, 90 degree, 45 degree, or 60 degree or may be another degree. In one variation, fibers in the first core 22, the second core 24, or the skin 26, or any combination thereof may be bundled prior to manufacture or may be bundled during manufacture. In one variation the first core 22, second core 24, skin 26, and bonding agent 30 may be positioned within a mold, compacted, and cured. In one variation, a first core 22 may be positioned into a mold cavity. The skin 26 may be preimpregnated, coated, saturated, positioned in a layer, or otherwise contacted with the bonding agent 30 in one variation. In other variations the bonding agent 30 may be coated, saturated, positioned in a layer, or otherwise contacted with the first core 22. The skin 26 may be at positioned to at least partially overlay, overlay, partially surround, or fully surround the first core 22. The mold may be closed and cured to form a cured composite material 20. In one variation, a second core 24 may be positioned into a mold cavity. The skin 26 may be preimpregnated, coated, saturated, positioned in a layer, or otherwise contacted with the bonding agent 30 in one variation. In other variations the bonding agent 30 may be coated, saturated, positioned in a layer, or otherwise contacted with the second core 24. The skin 26 may be at positioned to at least partially overlay, overlay, partially surround, or fully surround the second core 24. The mold may be closed and cured to form a cured composite material 20. In one variation, a first core 22, and a second core 24 may be positioned into a mold cavity. The skin 26 may be preimpregnated, coated, saturated, positioned in a layer, or otherwise contacted with the bonding agent 30 in one variation. In other variations the bonding agent 30 may be coated, saturated, positioned in a layer, or otherwise contacted with the second core 24. In other variations the bonding agent 30 may be coated, saturated, positioned in a layer, or otherwise contacted with the first core 22. The skin 26 may be at positioned to at least partially overlay, overlay, partially surround, or fully surround the first core 22, the second core 24, both or neither. The mold may be closed and cured to form a cured composite material 20. The orientation of the first core 22 and the second core 24 relative to the skin 26 may be adapted to fit the application of the composite material 20. The second core 24 can be adjacent to, in contact with, partially overlaying, fully overlaying, fully surrounding, partially surrounding, partially surrounded by, or fully surrounded by the first core 22. In a number of variations the heat of the moulding process may be in a range between 240 and 260° F. In a number of variations the pressure of the moulding process may be between 30-700 tons. In a number of variations the time of the moulding process may be between 3-6 minutes. In a number of variations the time of the moulding process may be about 4 minutes. Other methods may be used to form the composite material 20. These methods include, but are not limited to, hand lay-up operation, a spray lay-up operation, a pultrusion operation, a chopped strand mat, vacuum bag moulding, pressure bag moulding, autoclave moulding, resin transfer moulding, injection moulding, polymeric liquid composite moulding, vacuum assisted resin transfer moulding, bladder moulding, compression moulding, mandrel wrapping, face sheet rolling, wet layup, chopper gun, filament winding, or may be formed another way. The composite material 20 may be formed to sheets in an orientation of the first core 22, second core 24, skin 26, and bonding agent 30 in any combination or layer formation. The composite material 20 may be finished with other methods for a final design. The mold may be tooled to form the desired shape or variation of the composite material 20 for its intended application. A person of skill in the art would recognize these techniques.

In one variation a first skin 50 and first bonding agent 52 may be positioned into a mold cavity. The first skin 50 may be preimpregnated with the first bonding agent 52 in one variation. In other variations the first bonding agent 52 may be coated, saturated, positioned in a layer, or otherwise contacted with the first skin 50. The first bonding agent 52 may also be preimpregnated, coated, saturated, positioned in a layer, or otherwise contacted with the first core 54 or second core 56 or other components. In one variation a first core 54, a second core 56, both or neither may be positioned over the first skin 50 in the mold cavity. The first bonding agent 52 may be positioned between the first skin 50 and the first core 54, between the first skin 50 and the second core 56, or between the first skin 50 and the first core 52 as well as the second core 56. The orientation of the first core 54 and the second core 56 relative to the first skin 50 may be adapted to fit the application of the composite material 20. The second core 56 can be adjacent to, in contact with, partially overlaying, fully overlaying, fully surrounding, partially surrounding, partially surrounded by, or fully surrounded by the first core 54. The first core 54, the second core 56, both or neither may be machined and shaped to fit the application of the composite material 20. In one variation a first core 54 may be positioned over the second core 56. In one variation a second core 56 may be positioned over the first core 54. In one variation a second skin 60 may be positioned over the first core 54, the second core 56, both or neither. The second skin 60 may be preimpregnated with a second bonding agent 62 in one variation. In other variations the second bonding agent 62 may be coated, saturated, positioned in a layer, or otherwise contacted with the second skin 60. The second bonding agent 62 may also be preimpregnated, coated, saturated, positioned in a layer, or otherwise contacted with the first core 54 or second core 56 or other components. The second bonding agent may be positioned between the second skin 60 and the first core 54, between the second skin 60 and the second core 56, or between the second skin 60 and the first core 54 as well as the second core 56. A mold 70 may be closed in one variation to form and cure a composite material 20 as shown in FIG. 1. In a number of variations the heat of the moulding process may be in a range between 240 and 260° F. In a number of variations the pressure of the moulding process may be between 30-700 tons. In a number of variations, the time of the moulding process may be between 3-6 minutes. In a number of variations the time of the moulding process may be about 4 minutes. Other methods may be used to form the composite material 20. These methods include, but are not limited to, hand lay-up operation, a spray lay-up operation, a pultrusion operation, a chopped strand mat, vacuum bag moulding, pressure bag moulding, autoclave moulding, resin transfer moulding, injection moulding, polymeric liquid composite moulding, vacuum assisted resin transfer moulding, bladder moulding, compression moulding, mandrel wrapping, wet layup, chopper gun, filament winding, or may be formed another way. The composite material 20 may be formed to sheets in an orientation of the first skin 50, first bonding agent 52, first core 54, second core 56, second skin 60, and second bonding agent 62 in any combination or layer formation. The composite material 20 may be finished with other methods for a final design. The mold may be tooled to form the desired shape or variation of the composite material 20 for its intended application. A person of skill in the art would recognize these techniques.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a composite material including a first core, a second core including foam, a bonding agent, and a skin, wherein the skin at least partially overlays the first core and the second core.

Variation 2 may include a product as set forth in Variation 1 wherein the second core further includes polyester.

Variation 3 may include a product as set forth in any of Variations 1-2 wherein the bonding agent includes a liquid resin including vinylester.

Variation 4 may include a product as set forth in any of Variations 1-3 wherein the first core includes at least one fiber including a fiberglass including at least one of E-glass, A-glass, E-CR-glass, C-glass, D-glass, R-glass, F-glass, S-glass, S-2-glass, or Hexel.

Variation 5 may include a product as set forth in any of Variations 1-4 wherein the skin includes at least one fiber including a fiberglass including at least one of E-glass, A-glass, E-CR-glass, C-glass, D-glass, R-glass, F-glass, S-glass, S-2-glass, or Hexel.

Variation 6 may include a product as set forth in any of Variations 1-5 wherein the skin includes at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

Variation 7 may include a product as set forth in any of Variations 1-6 wherein the first core includes at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

Variation 8 may include a product as set forth in any of Variations 1-7 wherein the second core has a density ranging between 6 lbs/ft² and 24 lbs/ft².

Variation 9 may include a product as set forth in any of Variations 1-8 wherein the second core at least partially overlays the first core.

Variation 10 may include a product as set forth in any of Variations 1-9 wherein the second core at least partially surrounds the first core.

Variation 11 may include a product as set forth in any of Variations 1-10 wherein the skin at least partially surrounds the first core and the second core.

Variation 12 may include a method of manufacturing a composite material including: providing a first core, a second core, a first skin, a second skin, and a first bonding agent a second bonding agent, and a mold cavity, positioning the first skin in the mold cavity, positioning the first bonding agent in contact with the first skin, positioning the second core over the first skin, positioning the first core over the first skin, positioning the second bonding agent in contact with the second skin, positioning the second skin over the second core and the first core, and, curing to form the composite material.

Variation 13 may include a method as set forth in Variation 12 wherein the first bonding agent and the second bonding agent includes a liquid resin including vinylester.

Variation 14 may include a method as set forth in any of Variations 12-13 wherein the second core includes foam including polyester.

Variation 15 may include a method as set forth in Variations 12-14 wherein the first core includes at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

Variation 16 may include a method as set forth in any of Variations 12-15 wherein the first skin includes at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

Variation 17 may include a method as set forth in any of Variations 12-16 wherein the second skin includes at least one fiber including at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

Variation 18 may include a method as set forth in any of Variations 12-17 wherein the first core includes at least one fiber including a fiberglass including at least one of E-glass, A-glass, E-CR-glass, C-glass, D-glass, R-glass, F-glass, S-glass, S-2-glass, or Hexel.

Variation 19 may include a method as set forth in any of Variations 12-18 wherein at least one of the first skin or the second skin includes at least one fiber including a fiberglass including at least one of E-glass, A-glass, E-CR-glass, C-glass, D-glass, R-glass, F-glass, S-glass, S-2-glass, or Hexel.

Variation 20 may include a method as set forth in any of Variations 12-19 wherein the curing temperature is within the range of 240 to 260° F., wherein the curing pressure is within the range of 300-700 tons moulding pressure, and wherein the curing time is about 4 minutes.

Variation 21 may include a product as set forth in any of Variations 1-11 wherein the composite material includes a plurality of layers.

Variation 22 may include a product as set forth in any of Variations 1-11 and 21 wherein the first core includes sheets, continuous mats, or as continuous filaments.

Variation 23 may include a product as set forth in any of Variations 1-11 and 21-22 wherein the first core is manufactured or woven through weaving, knitting, braiding, stitching, plain weaving, or satin weaving of any degree.

Variation 24 may include a product as set forth in any of Variations 1-11 and 21-23 wherein the first core is manufactured in a two dimensional or a three dimensional orientation.

Variation 25 may include a product as set forth in any of Variations 1-11 and 21-24 wherein the first core is formed using at least one of a hand lay-up operation, an extrusion operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, or continuous filament methods.

Variation 26 may include a product as set forth in any of Variations 1-11 and 21-25 wherein the first core further includes at least one of short-fiber reinforced materials or continuous fiber-reinforced materials.

Variation 27 may include a product as set forth in any of Variations 1-11 and 21-26 wherein the skin is manufactured in a two dimensional or three dimensional orientation.

Variation 28 may include a product as set forth in any of Variations 1-11 and 21-27 wherein the second core is formed by sheets, continuous mats, or as continuous filaments.

Variation 29 may include a product as set forth in any of Variations 1-11 and 21-28 wherein the second core is manufactured or woven through weaving, knitting, braiding, stitching, plain weaving, or satin weaving of any degree.

Variation 30 may include a product as set forth in any of Variations 1-11 and 21-29 wherein the second core is manufactured in a two dimensional or three dimensional orientation

Variation 31 may include a product as set forth in any of Variations 1-11 and 21-30 wherein the second core is formed using at least one of a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, or continuous filament methods.

Variation 32 may include a product as set forth in any of Variations 1-11 and 21-31 wherein the second core includes short-fiber reinforced materials or continuous fiber-reinforced materials.

Variation 33 may include a product as set forth in any of Variations 1-11 and 21-32 wherein the second core includes an open-cell foam or a closed-cell foam.

Variation 34 may include a product as set forth in any of Variations 1-11 and 21-33 wherein the second core includes at least one of a ballistic foam, a nanofoam, a syntactic foam, an integral skin foam, a solid foam, a liquid foam, a low-density foam, a high-density foam, an alcohol resistant foam, a low expansion foam, or a high expansion foam.

Variation 35 may include a product as set forth in any of Variations 1-11 and 21-34 wherein the second core further includes a foam including at least one of a polyurethane, polyester, alumina, beryllia, ceria, zirconia, silicide, nitride, boride, carbide, a surfactant, an organic solvent, a protein foam, Evlon, rubber, Supreem, Rebond, Memory Foam, Polyether, Polyethylene, Crosslinked Polyethylene, Latex, Neoprene, Ethafoam, Polystyrene, Styrofoam, Polyfoam, Nimbus, or IMPAXX.

Variation 36 may include a product as set forth in any of Variations 1-11 and 21-35 wherein the skin is formed by sheets, continuous mats, or as continuous filaments.

Variation 37 may include a product as set forth in any of Variations 1-11 and 21-36 wherein the skin is manufactured or woven through weaving, knitting, braiding, stitching, plain weaving, or satin weaving of any degree.

Variation 38 may include a product as set forth in any of Variations 1-11 and 21-37 wherein the skin is formed using at least one of a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, or continuous filament methods.

Variation 39 may include a product as set forth in any of Variations 1-11 and 21-38 wherein the skin includes short fiber-reinforced materials or continuous fiber-reinforced materials.

Variation 40 may include a product as set forth in any of Variations 1-11 and 21-39 wherein the bonding agent includes at least one of urethane resin, polyester resin, epoxy resin, phenolic resin, or modified phenolic resin.

Variation 41 may include a product as set forth in any of Variations 1-11 and 21-40 wherein the bonding agent reacts with at least one of the skin, the first core, or the second core.

Variation 42 may include a method as set forth in any of Variations 12-20, wherein fibers in the first core, the second core, or the skin may be bundled prior to manufacture or after manufacture.

Variation 43 may include a method as set forth in any of Variations 12-20, and 42 wherein the first core, second core, skin, and bonding agent 30 are positioned within a mold and cured.

Variation 44 may include a method as set forth in any of Variations 12-20, and 43-43 wherein the first core, skin, and bonding agent are positioned within a mold and cured.

Variation 45 may include a method as set forth in any of Variations 12-20, and 43-44 wherein the second core, skin, and bonding agent are positioned within a mold and cured.

Variation 46 may include a method as set forth in any of Variations 12-20, and 43-45 wherein the skin at least partially overlays, overlays, partially surrounds, or fully surrounds the first core.

Variation 47 may include a method as set forth in any of Variations 12-20, and 43-46 wherein the skin at least partially overlays, overlays, partially surrounds, or fully surrounds the second core.

Variation 48 may include a method as set forth in any of Variations 12-20, and 43-47 wherein the first core at least partially overlays, overlays, partially surrounds, or fully surrounds the second core.

Variation 49 may include a method as set forth in any of Variations 12-20, and 43-48 wherein the second core at least partially overlays, overlays, partially surrounds, or fully surrounds the first core.

Variation 50 may include a method as set forth in any of Variations 12-20, and 43-49 wherein the bonding agent is preimpregnated, coated, saturated, positioned in a layer, or otherwise contacted with the first core.

Variation 51 may include a method as set forth in any of Variations 12-20, and 43-50 wherein the bonding agent is preimpregnated, coated, saturated, positioned in a layer, or otherwise contacted with the second core.

Variation 52 may include a method as set forth in any of Variations 12-20, and 43-51 wherein the bonding agent is preimpregnated, coated, saturated, positioned in a layer, or otherwise contacted with the skin.

Variation 53 may include a method as set forth in any of Variations 12-20, and 43-52 wherein the composite material is formed by at least one of hand lay-up operation, a spray lay-up operation, a pultrusion operation, a chopped strand mat, vacuum bag moulding, pressure bag moulding, autoclave moulding, resin transfer moulding, injection moulding, polymeric liquid composite moulding, vacuum assisted resin transfer moulding, bladder moulding, compression moulding, mandrel wrapping, face sheet rolling, wet layup, chopper gun, or filament winding method.

Variation 54 may include a method as set forth in any of Variations 12-20, and 43-53 wherein the bonding agent is preimpregnated, coated, saturated, positioned in a layer, or otherwise contacted with the skin.

The above description of select variations is merely illustrative in nature and, thus, variations or variants thereof are not to be regarded as a departure from the spirit and scope of the invention.

What is claimed is:

1. A product comprising:
a composite material comprising a first core, a second core comprising foam, a bonding agent, and a skin, wherein the skin at least partially overlays the first core and the second core.

2. A product as described in claim 1 wherein the second core further comprises polyester.

3. A product as described in claim 1 wherein the bonding agent comprises a liquid resin comprising vinylester.

4. A product as described in claim 1 wherein the first core comprises at least one fiber comprising a fiberglass comprising at least one of E-glass, A-glass, E-CR-glass, C-glass, D-glass, R-glass, F-glass, S-glass, S-2-glass, or Hexel.

5. A product as described in claim 1 wherein the skin comprises at least one fiber comprising a fiberglass comprising at least one of E-glass, A-glass, E-CR-glass, C-glass, D-glass, R-glass, F-glass, S-glass, S-2-glass, or Hexel.

6. A product as described in claim 1 wherein the skin comprises at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

7. A product as described in claim 1 wherein the first core comprises at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

8. A product as described in claim 1 wherein the second core has a density ranging between 6 lbs/ft² and 24 lbs/ft².

9. A product as described in claim 1 wherein the second core at least partially overlays the first core.

10. A product as described in claim 1 wherein the second core at least partially surrounds the first core.

11. A product as described in claim 1 wherein the skin at least partially surrounds the first core and the second core.

12. A method of manufacturing a composite material comprising:
providing a first core, a second core, a first skin, a second skin, and a first bonding agent, a second bonding agent, and a mold cavity,
positioning the first skin in the mold cavity
positioning the first bonding agent in contact with the first skin,
positioning the second core over the first skin,
positioning the first core over the first skin,
positioning the second bonding agent in contact with the second skin,
positioning the second skin over the second core and the first core,
and, curing to form the composite material.

13. A method as described in claim 12 wherein the first bonding agent and the second bonding agent comprise a liquid resin comprising vinylester.

14. A method as described in claim 12 wherein the second core comprises foam comprising polyester.

15. A method as described in claim 12 wherein the first core comprises at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

16. A method as described in claim 12 wherein the first skin comprises at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

17. A method as described in claim 12 wherein the second skin comprises at least one fiber comprising at least one of alpaca, angora, byssus, camel hair, cashmere, catgut, chiengora, guanaco, llama, mohair, pashmina, qiviut, rabbit, silk, sinew, spider silk, wool, vicuna, yak, abaca', bagasse, balsa wood, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, carbon nanotube reinforced polymer, fiber reinforced polymer, basalt, stainless steel, titanium, steel, cast iron, alloy steel, stainless steel, platinum, palladium, aluminum, copper, nickel, iron, lead, tin, cobalt, or bronze.

18. A method as described in claim 12 wherein the first core comprises at least one fiber comprising a fiberglass comprising at least one of E-glass, A-glass, E-CR-glass, C-glass, D-glass, R-glass, F-glass, S-glass, S-2-glass, or Hexel.

19. A method as described in claim 12 wherein at least one of the first skin or the second skin comprises at least one fiber comprising a fiberglass comprising at least one of E-glass, A-glass, E-CR-glass, C-glass, D-glass, R-glass, F-glass, S-glass, S-2-glass, or Hexel.

20. A method as described in claim 12 wherein the curing temperature is within the range of 240 to 260° F., wherein the curing pressure is within the range of 300-700 tons moulding pressure, and wherein the curing time is about 3 to 6 minutes.
